(19) United States
(12) Patent Application Publication
(10) Pub. No.: US 2005/0237031 A1
(43) Pub. Date: Oct. 27, 2005

(54) Power supply, charging apparatus, and charging system

(75) Inventors: Kazuya Ogawa, Tokyo (JP); Tsuyoshi Iijima, Tokyo (JP); Satoshi Maruyama, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/074,701

(22) Filed: Mar. 9, 2005

(30) Foreign Application Priority Data
Mar. 12, 2004 (JP) P2004-071450

(51) Int. Cl. H02J 7/00

(52) U.S. Cl. 320/156

(57) ABSTRACT

A secondary battery comprises lithium-ion secondary battery elements each including a pair of electrodes and a resistor electrically connected to at least one polarity side of the pair of electrodes.

### BACKGROUND OF THE INVENTION

1. Field of the Invention

The present invention relates to a power supply, a charging apparatus, and a charging system.

2. Related Background Art

Along with recent dissemination and development of various portable devices, power supplies using secondary batteries such as lithium-ion secondary battery have been desired to further lower their cost and improve their characteristics. One of the characteristics expected to improve in such a power supply is the rapid charging characteristic. Conventional secondary battery charging methods mainly include constant current charging, constant current/constant voltage charging, and constant voltage charging (see Japanese Patent Application Laid-Open No. H 5-111184, Japanese Patent Application Laid-Open No. H 7-296853, Japanese Patent Application Laid-Open No. H 8-45550, Japanese Patent Application Laid-Open No. H 5-21093).

The constant current charging is a method in which a charging voltage is controlled such as to attain a predetermined charging current, and the charging to a secondary battery is stopped when the charging voltage reaches a predetermined full charge voltage (e.g., 4.2 V). When the charging voltage approaches the full charge voltage in the constant current charging, the charging efficiency deteriorates under the influence of IR drop and polarization, whereby the charging amount is likely to be in short. This tendency becomes remarkable in particular when rapid charging is performed. When the constant current charging is further carried out to a voltage higher than the full charge voltage in order to complement the charging amount after the full charge voltage is attained in the case using such constant current charging, an overcharged state partly occurs within a positive or negative electrode in the secondary battery, thereby decomposing electrolytes or generating gases.

In the constant current/constant voltage charging method, which has been usually employed for charging the lithium-ion secondary battery, constant current charging is performed until the charging voltage reaches a full charge voltage, then the charging is switched to constant voltage charging at the full charge voltage, and the charging is terminated when the charging current becomes a predetermined value or lower. This is more likely to overcome the shortage in charging amount than is the constant current charging, but complicates charging apparatus circuits and causes the cost to increase.

On the other hand, the constant voltage charging is a method supplying a secondary battery with a constant charging voltage. When the charging voltage is set appropriately, there is no fear of overcharging the secondary battery. When the charging time and charging stop current value are set appropriately, a sufficient charging amount can be obtained, and rapid charging is possible. Also, charging apparatus circuits become simpler than those in the constant current/constant voltage charging, whereby the cost can be expected to decrease.

### SUMMARY OF THE INVENTION

When the constant voltage charging method is performed, however, a very large charging current flows into the secondary battery at the initial stage of charging. According to studies conducted by the inventors, there are cases where the charging apparatus itself generates a large amount of heat when such a large charging current occurs, which may be disadvantageous in terms of safety. When such a charging current flows into the secondary battery, the nonuniformity in electrochemical reactions increases on the cathode and anode of the secondary battery, whereby a partly overcharged state, its resulting electrolyte decomposition, and the like occur. In a lithium-ion secondary battery, ions such as lithium ions may fail to completely intercalate on the anode. When lithium ions do not completely intercalate on the anode, for example, lithium may be deposited as dendrite, thus causing a large capacity deterioration and inner short-circuiting as charging/discharging cycles progress.

In view of the problem mentioned above, it is an object of the present invention to provide a power supply, a charging apparatus, and a charging system which can suppress a charging current flowing into a secondary battery at an initial state of charging even when the constant voltage charging method is performed.

The power supply in accordance with the present invention comprises a secondary battery including a pair of electrodes; and a resistor electrically connected to at least one polarity side of the pair of electrodes.

The charging apparatus in accordance with the present invention comprises a first terminal to be electrically connected to an electrode on one polarity side of a secondary battery; a second terminal to be electrically connected to an electrode on the other polarity side of the secondary battery; constant voltage generating means for generating a constant voltage between a pair of output terminals; and a resistor; wherein one of the output terminals of the constant voltage generating means is electrically connected to the first terminal; and wherein the other terminal of the constant voltage generating means is electrically connected to the second terminal by way of the resistor.

The charging system in accordance with the present invention comprises a secondary battery including a pair of electrodes; a first terminal electrically connected to an electrode on one polarity side of the secondary battery; a second terminal electrically connected to an electrode on the other polarity side of the secondary battery; constant voltage generating means for generating a constant voltage between a pair of output terminals; and a resistor; wherein one of the output terminals of the constant voltage generating means is electrically connected to the first terminal; and wherein the other terminal of the constant voltage generating means is electrically connected to the second terminal by way of the resistor.

When a secondary battery is charged with a constant voltage applied from constant voltage generating means in the present invention, a resistor intervenes between the secondary battery and the constant voltage generating means. Therefore, when the charging current flowing into the secondary battery at the initial stage of charging is relatively large, the voltage drop caused by the resistance of the resistor lowers the voltage applied to the secondary battery as compared with that in the case without the resistor, whereby the charging current is suppressed. When the charging current to the secondary battery decreases at the end stage of charging, the voltage drop caused by the resistance of the resistor becomes smaller, so that the voltage from the constant voltage generating means is fully applied to the secondary battery, whereby the secondary battery is sufficiently charged.

Preferably, the secondary battery comprises a plurality of secondary battery elements connected in parallel. In this case, a power supply having a large capacity can be obtained easily.

Preferably, an ohmic value of the resistor is 1.5 to 25 times a DC internal resistance value of the secondary battery.

When this condition is satisfied, the current value applied to the secondary battery can be suppressed to about 50 to 5 C. Here, the DC internal resistance value of the secondary battery is a value calculated from a relationship between current values and voltage drops obtained by causing DC currents ranging from 1 C to 10 C to flow into the secondary battery for 10 seconds and determining the resulting voltage drops.

Preferably, the power supply further comprises a package for accommodating the secondary battery; a first lead having one end disposed within the package and electrically connected to the electrode on the one polarity side of the secondary battery, and the other end projecting out of the package; and a second lead having one end disposed within the package and electrically connected to the electrode on the other polarity side of the secondary battery, and the other end projecting out of the package; wherein the resistor is connected to a middle part of at least one of the first and second leads.

Such a power supply is easy to manufacture and handle.

When the resistor is connected to a middle part of a portion of a lead accommodated in the package, the part of lead exposed to the outside is similar to that in a conventional power supply, whereby the lead can easily be connected to an external load or a charging apparatus.

When the resistor is connected to a middle part of a portion of a lead exposed to the outside of the package, on the other hand, an end part (outer part) of the lead can be used for charging the secondary battery by way of the resistor, whereas the inner part of the lead on the side opposite from the end part across the resistor can be used for discharging the secondary battery without the aid of the resistor.

Specifically, the resistor can be formed from materials such as alloys like nickel-copper and copper-manganese, and conductive polymers.

Preferred as the secondary battery is a lithium-ion secondary battery.

As mentioned above, the present invention provides a power supply, a charging apparatus, and a charging system which can suppress currents flowing into secondary battery elements at an initial stage of charging even when the constant voltage charging is performed.

### BRIEF DESCRIPTION OF THE DRAWINGS

FIG. 1 is a schematic view showing the power supply, charging apparatus, and charging system in accordance with a first embodiment;

FIG. 2 is a sectional view of the power supply taken along the YZ plane of FIG. 1;

FIG. 3 is a view of the power supply as seen along the XZ plane of FIG. 1;

FIG. 4 is a sectional view showing a step of making the power supply of FIG. 1;

FIG. 5 is a perspective view showing a method of manufacturing the power supply in the order of (a) and (b);

FIG. 6 is a schematic view showing the power supply, charging apparatus, and charging system in accordance with a second embodiment; and

FIG. 7 is a schematic view showing the power supply, charging apparatus, and charging system in accordance with a third embodiment.

### DESCRIPTION OF THE PREFERRED EMBODIMENTS

In the following, preferred embodiments of the present invention will be explained in detail with reference to the drawings. In the following explanation, parts identical or equivalent to each other will be referred to with numerals identical to each other without repeating their overlapping descriptions.

First Embodiment

First, an embodiment of a power supply in accordance with the present invention equipped with a lithium-ion secondary battery will be explained in detail.

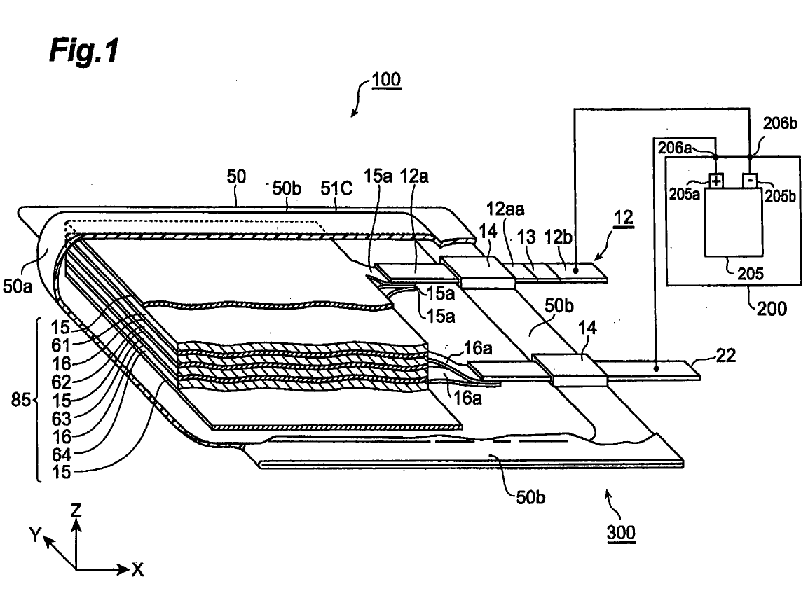

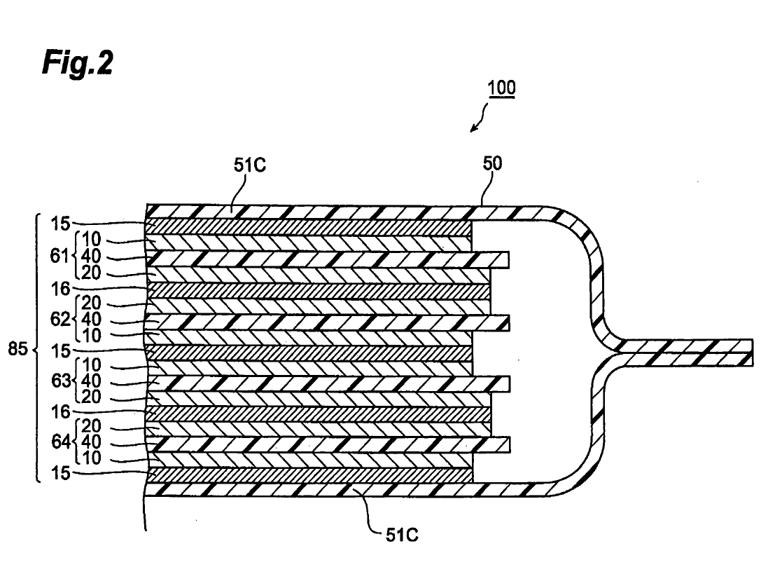

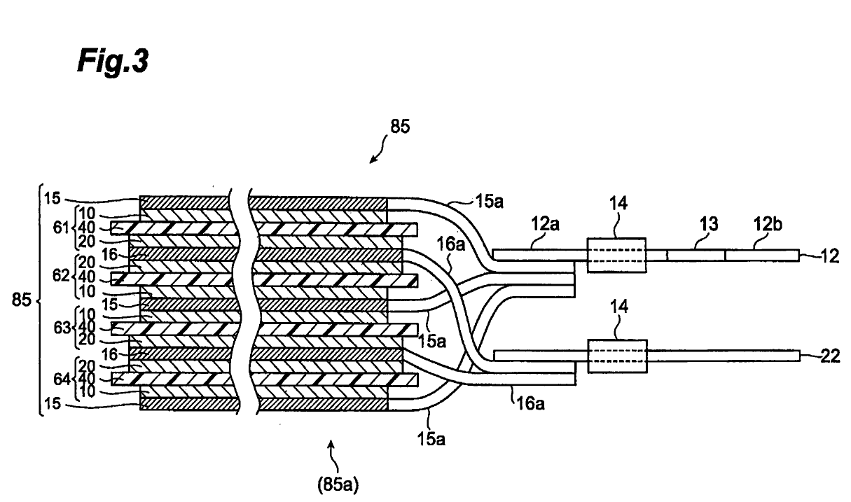

FIG. 1 is a partly broken perspective view showing a power supply 100 in accordance with a first embodiment of the present invention. FIG. 2 is a sectional view taken along the YZ plane of FIG. 1. FIG. 3 is a view showing a lithium-ion secondary battery 85, and leads 12 and 22 as seen in the ZX cross section of FIG. 1.

As shown in FIGS. 1 to 3, the power supply 100 in accordance with this embodiment is mainly constituted by the lithium-ion secondary battery 85, a case (package) 50 accommodating the lithium-ion secondary battery 85 in a closed state, and the leads 12 and 22 for connecting the lithium-ion secondary battery 85 to the outside of the case 50. The lithium-ion secondary battery 85 comprises, successively from the upper side, a collector 15, a lithium-ion secondary battery element (secondary battery element) 61, a collector 16, a lithium-ion secondary battery element (secondary battery element) 62, a collector 15, a lithium-ion secondary battery element (secondary battery element) 63, a collector 16, a lithium-ion secondary battery element (secondary battery element) 64, and a collector 15. The secondary battery elements 61 to 64 are connected in parallel, so as to construct one secondary battery.

Lithium-Ion Secondary Battery Element

As shown in FIG. 2, each of the lithium-ion secondary battery elements is constituted by a planar cathode (electrode) 10 and a planar anode (electrode) 20 which oppose each other; a planar electrically insulating separator 40 disposed between the cathode 10 and anode 20 adjacent thereto; and an electrolytic solution (not depicted) which includes an electrolyte and is contained in the cathode 10, anode 20, and separator 40.

The lithium-ion secondary battery elements 61 to 64 are laminated such that the anodes 20 and cathodes 10 are in contact with the collectors 16 and 15, respectively. For convenience of explanation, the anode and cathode are determined according to polarities of the lithium-ion secondary battery 85 at the time of discharging. When charging the lithium-ion secondary battery, electric charges flow in directions opposite from those at the time of discharging, whereby the anode and cathode replace each other.

Anode

Each anode 20 is a layer including an anode active material, a conductive auxiliary agent, a binder, and the like. In the following, the anode 20 will be explained.

The anode active material is not limited in particular as long as it can reversibly advance occlusion/release of lithium ions, desorption/insertion of lithium ions, or doping/undoping of lithium ions with their counter anions (e.g., ClO₄⁻), whereby materials similar to those used in known lithium-ion secondary battery elements can be employed. Examples of the materials include carbon materials such as natural graphite, synthetic graphite, mesocarbon microbeads, mesocarbon fiber, coke, glassy carbon, and sintered organic compounds; metals such as Al, Si, and Sn adapted to combine with lithium; amorphous compounds mainly composed of oxides such as SiO₂ and SnO₂; and lithium titanate (Li₄Ti₅O₁₂)

Preferred among them are carbon materials. More preferred are carbon materials having an interlayer distance d₀₀₂ of 0.335 to 0.338 nm and a crystallite size Lc₀₀₂ of 30 to 120 nm. Examples of carbon materials satisfying such conditions include synthetic graphite and MCF (mesocarbon fiber). The above-mentioned interlayer distance d₀₀₂ and crystallite size Lc₀₀₂ can be determined by X-ray diffraction.

The conductive auxiliary agent is not restricted in particular as long as it ameliorates the conductivity of the anode 20, whereby known conductive auxiliary agents can be used. Examples of the conductive auxiliary agent include carbon blacks; carbon materials; fine powders of metals such as copper, nickel, stainless, and iron; mixtures of carbon materials and fine metal powders; and conductive oxides such as ITO.

The binder is not restricted in particular as long as it can bind particles of the above-mentioned anode active material and conductive auxiliary agent to the collector 16, whereby known binders can be used. Its examples include fluorine resins such as polyvinylidene fluoride (PVDF), polytetrafluoroethylene (PTFE), tetrafluoroethylene/hexafluoropropylene copolymer (FEP), tetrafluoroethylene/perfluoroalkylvinyl ether copolymer (PEA), ethylene/tetrafluoroethylene copolymer (ETFE), polychlorotrifluoroethylene (PCTFE), ethylene/chlorotrifluoroethylene copolymer (ECTFE), and polyvinyl fluoride (PVF); and styrene/butadiene rubber (SBR).

The material of the collectors 16 binding with their corresponding anodes 20 is not restricted in particular as long as it is a metal material usually employed as an anode collector for a lithium-ion secondary battery element. Its examples include copper and nickel. Each collector 16 extends outward so as to form a tongue 16a at an end thereof as shown in FIGS. 1 and 3. The tongues 16a are grouped into a single bundle, which is electrically connected to a lead 22 which will be explained later.

Cathode

Each cathode 10 is a layer including a cathode active material, a conductive auxiliary agent, a binder, and the like. In the following, the cathode 10 will be explained.

The cathode active material is not limited in particular as long as it can reversibly advance occlusion/release of lithium ions, desorption/insertion (intercalation) of lithium ions, or doping/undoping of lithium ions with their counter anions (e.g., ClO₄⁻), whereby materials used in known lithium-ion secondary battery elements can be employed. Examples of the materials include lithium cobaltate (LiCoO₂); lithium nickelate (LiNiO₂); lithium manganese spinel (LiMn₂O₄); mixed metal oxides represented by the general formula of LiNiₓCo_{y}Mn_{z}O₂ (x+y+z=1); and mixed metal oxides such as lithium vanadium compound (LiV₂O₅), olivine type LiMPO₄ (where M is Co, Ni, Mn, or Fe), and lithium titanate (Li₄Ti₅O₁₂)

For constituents other than the cathode active material contained in the cathode 10, materials similar to those constituting the anode 20 can be used. Electronically conductive particles similar to those in the anode 20 are preferably contained in the cathode 10 as well.

The material of the collectors 15 binding with their corresponding cathodes 10 is not restricted in particular as long as it is a metal material usually employed as a cathode collector for a lithium-ion secondary battery element. One of its examples is aluminum. Each collector 15 extends outward so as to form a tongue 15a at an end thereof as shown in FIGS. 1 and 3. The tongues 15a are grouped into a single bundle, which is electrically connected to an inner part 12a of a lead 12 which will be explained later. Thus, the lithium-ion secondary battery 85 is a secondary battery in which the lithium-ion secondary battery elements 61, 62, 63, 64 are connected in parallel.

Separator

The separator 40 disposed between the anode 20 and cathode 10 is not restricted in particular as long as it is formed from an electrically insulating porous body, whereby separators used in known lithium-ion secondary battery elements can be employed. Examples of the electrically insulating porous body include laminates of films constituted by polyethylene, polypropylene, and polyolefin; extended films of mixtures of the resins mentioned above; and fibrous nonwoven fabrics made of at least one kind of constituent material selected from the group consisting of cellulose, polyester, and polypropylene.

In each of the secondary battery elements 61 to 64, as shown in FIG. 3, the separator 40, anode 20, and cathode 10 reduce their areas in this order, the end faces of the anode 20 project out of the end faces of the cathode 10, and the end faces of the separator 40 project out of the end faces of the anode 20 and cathode 10.

As a consequence, even when the layers slightly deviate from each other in a direction intersecting their laminating direction because of errors at the time of manufacture and the like, the whole surface of the cathode 10 can easily oppose the anode 20 in each of the lithium-ion secondary battery elements 61 to 64. Therefore, lithium ions released from the cathode 10 are sufficiently taken into the anode 20 by way of the separator 40. When lithium ions are not sufficiently taken into the anode 20, those not taken into the anode 20 may be deposited, so that carriers of electric energy may decrease, thereby deteriorating the energy capacity of the battery. Since the separator 40 is greater than each of the cathode 10 and anode 20, and projects from the end faces of the cathode 10 and anode 20, the short-circuiting occurring when the cathode 10 and anode 20 come into contact with each other is reduced.

Electrolytic Solution

The electrolytic solution is contained in the anode 20 and cathode 10 and pores of the separator 40. The electrolytic solution is not restricted in particular, whereby electrolytic solutions (aqueous electrolytic solutions, and electrolytic solutions using organic solvents) used in known lithium-ion secondary battery elements can be employed. However, electrolytic solutions (nonaqueous electrolytic solutions) using organic solvents are preferred, since aqueous electrolytic solutions have such an electrochemically low decomposition voltage that the durable voltage at the time of charging is limited to a low level. As the electrolytic solution for lithium-ion secondary battery elements, one in which a lithium salt is dissolved in a nonaqueous solvent (organic solvent) is employed preferably. Examples of the lithium salt include salts such as LiPF₆, LiClO₄, LiBF₄, LiAsF₆, LiCF₃SO₃, LiCF₃, CF₂SO₃, LiC(CF₃SO₂)₃, LiN(CF₃SO₂)₂, LiN(CF₃CF₂SO₂)₂, LiN(CF₃SO₂) (C₄F₉SO₂), and LiN(CF₃CF₂CO)₂. These salts may be used either singly or in mixture of two or more species at any ratio.

As the organic solvents, those used in known lithium-ion secondary battery elements can be employed. Preferred examples include propylene carbonate, ethylene carbonate, and diethyl carbonate. They may be used either singly or in mixture of two or more species at any ratio.

In this embodiment, the electrolytic solution is not limited to a liquid, but may be a gelled electrolyte obtained by adding a gelling agent thereto. Instead of the electrolytic solution, a solid electrolyte (electrolyte made of a solid polymer electrolyte or ionically conductive inorganic material) may be contained as well.

Lead and Resistor

Leads (first and second leads) 12 and 22, each having a ribbon-like outer form, project out from within the case 50 by way of a seal part 50b as shown in FIG. 1. A resistor 13 is connected to a middle part of the lead 12.

Specifically, the lead 12 includes an inner part 12a located closer to the case 50 than is the resistor 13 and an outer part 12b disposed on the side opposite from the case 50 across the resistor 13, whereas the resistor 13 is connected between the inner part 12a and outer part 12b.

The inner part 12a extends from the inside of the case 50 to the outside thereof by way of the seal part 50b of the case 50, and is formed from a conductive material such as a metal. An end part of the portion closer to the lithium-ion secondary battery 85 in the inner part 12a is joined to the tongues 15a, 15a, 15a of the collectors 15, 15, 15 by resistance welding or the like, whereby the inner part 12a is electrically connected to the cathodes 10 by way of the respective collectors 15. As shown in FIGS. 1 and 3, the portion of the inner part 12a held by the seal part 50b of the case 50 is covered with an insulator 14 made of a resin or the like in order to enhance the sealability. For the inner part 12a, known conductive materials, e.g., aluminum, can be employed.

The resistor 13 is connected to the leading end of a portion of the inner part 12a which is exposed to the outside of the case 50. For the resistor 13, known resistor materials, such as titanium, stainless, nickel-copper alloys, nickel-chromium alloys, and copper-manganese alloys, for example, can be utilized. Though not restricted in particular, the ohmic value of the resistor 13 is preferably 1.5 to 25 times the DC internal resistance value of the lithium-ion secondary battery 85 in order for the current value applied to the lithium-ion secondary battery 85 to be suppressed to about 50 to 5 C at the time of charging. Here, the DC internal resistance value is a value calculated from a relationship between current values and voltage drops obtained by causing DC currents ranging from 1 C to 10 C to flow into the lithium-ion secondary battery 85 for 10 seconds and determining the resulting voltage drops.

Therefore, the length of the resistor 13 in the lead projecting direction and the cross-sectional area of the resistor 13 in a direction orthogonal to the lead projecting direction can be determined such that the ohmic value of the resistor 13 satisfies the above-mentioned condition according to the specific resistance of the resistor 13.

The outer part 12b is connected beyond the resistor 13, and further extends therefrom. The outer part 12b can use the same material as with the inner part 12a.

On the other hand, an end part of the lead 22 within the case 50 is welded to the tongues 16a, 16a of the collectors 16, 16, and is electrically connected to the anodes 20 by way of the respective collectors 16. For the lead 22, conductive materials such as copper and nickel can be used.

The lead 22 is also coated with an insulator 14 at the seal part 50b of the case 50 in order to enhance the sealability. Though not restricted in particular, each insulator 14 is preferably formed from a synthetic resin, for example. The leads 12 and 22 are separated from each other in a direction orthogonal to the laminating direction of the lithium-ion secondary battery 85.

The case 50 is not restricted in particular as long as it can seal the lithium-ion secondary battery 85 and prevent air and moisture from entering the case, whereby cases used in known lithium-ion secondary batteries can be employed. For example, a synthetic resin such as epoxy resin or a resin-laminated sheet of a metal such as aluminum can be used. As shown in FIG. 1, the case 50 is formed by folding a rectangular flexible sheet 51C into two at substantially the longitudinal center part, and holds the lithium-ion secondary battery 85 therebetween from both sides of the laminating direction (vertical direction). Among end parts of the sheet 51C folded into two, the seal part 50b in the three sides excluding the folding part 50a are bonded by heat sealing or an adhesive, whereas the lithium-ion secondary battery 85 is sealed therewithin. The case 50 is bonded to the insulators 14 at the seal part 50b, so as to seal leads 12, 22.

Manufacturing Method

An example of manufacturing method of the above-mentioned power supply 100 will now be explained.

First, respective coating liquids (slurries) containing constituent materials for forming electrode layers to become the anode 20 and cathode 10 are prepared The anode coating liquid is a solvent including the above-mentioned anode active material, conductive auxiliary agent, binder, and the like. The cathode coating liquid is a solvent including the above-mentioned cathode active material, conductive auxiliary agent, binder, and the like. The solvent used in each coating liquid is not restricted in particular as long as it can dissolve the binder and disperse the active material and conductive auxiliary agent. For example, N-methyl-2-pyrrolidone or N,N-dimethyl formamide can be used.

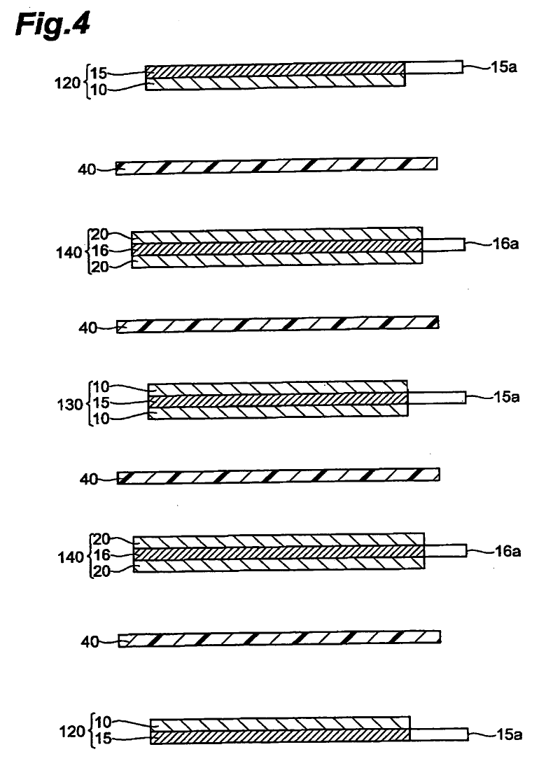

Next, collectors 15 made of aluminum or the like, and collectors 16 made of copper, nickel, or the like are prepared. Subsequently, as shown in FIG. 4, the cathode coating liquid is applied to one side of the collector 15 and then is dried, so as to form a cathode 10. Thus formed laminate is cut out into rectangular forms each having a tongue 15a, whereby two 2-layer laminates 120 shown in FIG. 4 are obtained for both ends. Similarly, the cathode coating liquid is applied to both sides of the collector 15 and then is dried, so as to form cathodes 10 on both sides. Thus formed laminate is cut out into a rectangular form having a tongue 15a, whereby one 3-layer laminate 130 for a cathode is obtained. The anode coating liquid is applied to both sides of the collector 16 and then is dried, so as to form anodes 20 on both sides. Thus formed laminate is cut into rectangular forms each having a tongue 16a, whereby two 3-layer laminates 140 for anodes are obtained. Techniques employed when applying the coating liquids to the collectors are not restricted in particular, but may be determined appropriately according to the material and form of metal plates for collectors, etc. Examples of the techniques include metal mask printing, electrostatic coating, dip coating, spray coating, roll coating, doctor blading, gravure coating, and screen printing. After the coating, pressing is effected by a flat press, calender rolls, or the like if necessary. Both faces of the tongues 15a, 16a are free of the cathode 10 and anode 20.

Here, as shown in FIGS. 3 and 4, the rectangle of the cathode 10 in each of the 2-layer laminates 120 and 3-layer laminate 130 is smaller than that of the anode 20 in each of the 3-layer laminates 140.

Subsequently, separators 40 are prepared. The separators 40 are made by cutting an insulating porous material into rectangles each greater than the rectangle of the anode 20 in each 3-layer laminate 140.

Next, the 2-layer laminates 120, 3-layer laminate 130, and 3-layer laminates 140 are laminated so as to alternate with the separators 40 in the order of FIG. 4, i.e., in the order of 2-layer laminate 120/separator 40/3-layer laminate 140/separator 40/3-layer laminate 130/separator 40/3-layer laminate 140/separator 40/2-layer laminate 120. Thus obtained laminate is heated while being held by center parts within planes on both sides of the laminating direction, whereby a laminate structure 85a laminated as shown in FIG. 3 is obtained.

Here, the layers of the laminate structure are arranged such that each separator 40 has one surface in contact with the cathode 10 and the other surface in contact with the anode 20. Further, the 2-layer laminates 120, 3-layer laminates 140, 3-layer laminate 130, and separators 40 are arranged in the laminate structure such that the end faces of the 3-layer laminates 140 for anodes project out of the end faces of the 2-layer laminates 120 and 3-layer laminate 130, whereas the end faces of the separators 40 project out of the end faces of the 3-layer laminates 140.

Subsequently, the lead 22 and the lead 12 having the resistor 13 interposed in the middle are made as shown in FIGS. 1 and 3. The lead 22 can easily be made by a known method, e.g., by cutting a metal plate into strips. The lead 12 having the resistor 13 interposed in the middle can easily be formed by holding both side faces of a thin elongated nickel-copper alloy plate acting as a resistor between respective side faces of a pair of nickel plates, joining the side faces together by resistance welding or the like, and then cutting the joined plate into strips extending in a direction orthogonal to the joined surfaces.

Then, as shown in FIG. 3, a portion located closer to the resistor 13 in the inner part 12a of the lead 12 and a part of the lead 22 are coated with insulators 14 made of a resin or the like.

Subsequently, as shown in FIG. 3, the tongues 15a of the laminate structure 85a are welded to the inner part 12a of the lead 12, whereas the tongues 16a are welded to an end part of the lead 22.

This completes the laminate structure 85a having the leads 12 and 22 connected thereto as shown in FIG. 3.

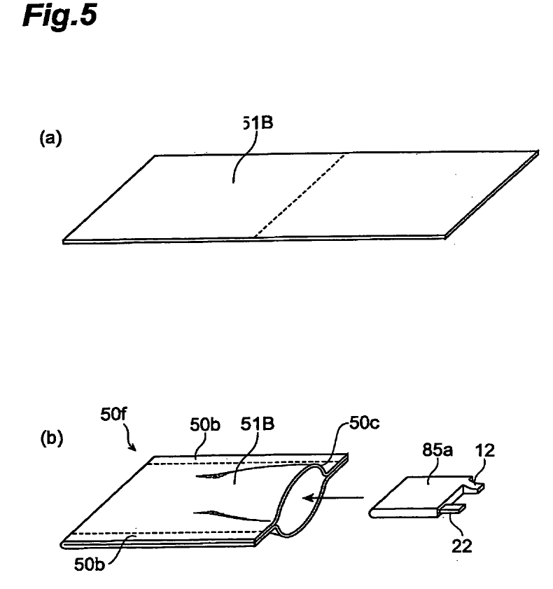

An example of method of making the case 50 will now be explained. First, as shown in (a) of FIG. 5, a rectangular sheet 51B in which aluminum is laminated with a thermally bondable resin layer is prepared.

Subsequently, the sheet 51B is folded along a dotted line at the center thereof into halves, which are overlaid on each other, and only the seal parts 50b, 50b in two sides are heat-sealed by a desirable seal width under a predetermined heating condition with a sealer, for example, as shown in (b) of FIG. 5. This yields a bag-shaped case 50f formed with an opening 50c for introducing the laminate structure.

Then, the laminate structure 85a having the leads 12 and 22 connected thereto is inserted into the case 50f in the state provided with the opening 50c. Subsequently, the electrolytic solution is injected into the case 50f within a vacuum container, so that the laminate structure 85a is dipped in the electrolytic solution, whereby the laminate structure 85a becomes the lithium-ion secondary battery 85. Thereafter, while in a state where each of the leads 12 and 22 partly projects out from within the case 50f whereas the resistor 13 of the lead 12 is totally exposed to the outside (see FIG. 1), the opening 50c of the case 50f is sealed with a sealer 82. Here, the parts of leads 12, 22 covered with the insulators 14 are sealed while being held by the opening 50c. This completes the making of the power supply 100.

Charging Method

A method of charging the lithium-ion secondary battery 85 of such a power supply 100, and a charging system 300 in accordance with this embodiment will now be explained. A charging apparatus 200 used for charging the lithium-ion secondary battery 85 of the power supply 100 includes a constant voltage power supply 205 and a pair of terminals 206a, 206b.

The constant voltage power supply 205 generates a predetermined constant DC voltage, e.g., at 4.2 V, between a pair of output terminals 205a, 205b. The output terminal 205a acting as a positive electrode is electrically connected to the terminal 206a, whereas the output terminal 205b acting as a negative electrode is electrically connected to the terminal 206b.

The terminal 206a of such a charging apparatus 200 is electrically connected to the exposed part of the lead 22, whereas the terminal 206b is electrically connected to the outer part 12b of the lead 12.

Here, the power supply 100 and the charging apparatus 200 constitute the charging system 300.

When a predetermined constant voltage, e.g., at 4.2 V, is applied from the constant voltage power supply 205, charging of the lithium-ion secondary battery elements 61, 62, 63, 64 in the lithium-ion secondary battery 85 of the power supply 100 begins.

When the charging capacity of each lithium-ion secondary battery element is small whereas the charging current flowing therein is relatively large at the initial stage of charging, a voltage drop caused by the resistance of the resistor 13 makes the voltage applied to the lithium-ion secondary battery elements 61 to 64 of the lithium-ion secondary battery 85 lower than the voltage of the constant voltage power supply 205 as compared with the,case without the resistor 13, whereby the charging current is suppressed. When the capacity of the lithium-ion secondary battery 85 becomes larger at the end stage of charging, so that the charging current flowing into each- of the lithium-ion secondary battery elements 61 to 64 becomes smaller, the voltage from the constant voltage power supply 205 is fully applied to the lithium-ion secondary battery elements 61 to 64, whereby sufficient charging is effected.

When discharging thus charged lithium-ion secondary battery 85, the outer part 12b of the lead 12 can be used as a terminal. Discharging without causing the voltage drop under the influence of the resistor 13 is possible when a portion 12aa exposed to the outside of the case 50 in the inner part 12a of the lead 12 is used as a terminal.

Though the lithium-ion secondary battery 85 is one having four lithium-ion secondary battery elements as single cells in this embodiment, the number of lithium-ion secondary battery elements may be more than 4 or not greater than 3, e.g., 1, as well.

Second Embodiment

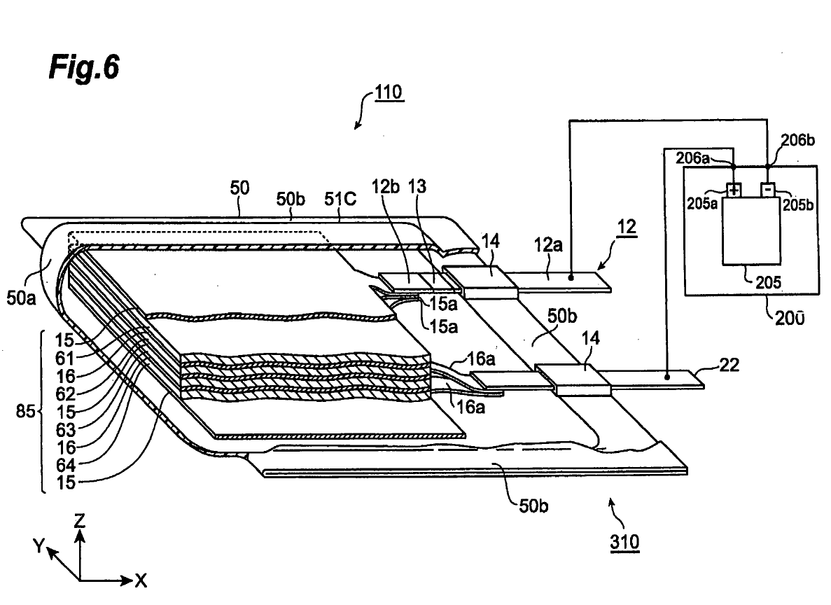

The power supply and charging system in accordance with a second embodiment of the present invention will now be explained with reference to FIG. 6. The power supply 110 in accordance with this embodiment differs from the power supply 100 of the first embodiment in that the resistor 13 in the lead 12 is disposed within the case 50. In this case, the outer part 12b of the lead 12 projects out from within the case 50. Here, the power supply 110 and the charging apparatus 200 constitute a charging system 310.

Such a power supply 110 exhibits operations and effects similar to those of the first embodiment when charged as in the first embodiment. Since the part of lead 12 exposed to the outside of the case 50 has a form similar to that conventionally employed, connections with external loads and charging apparatus are easy.

Third Embodiment

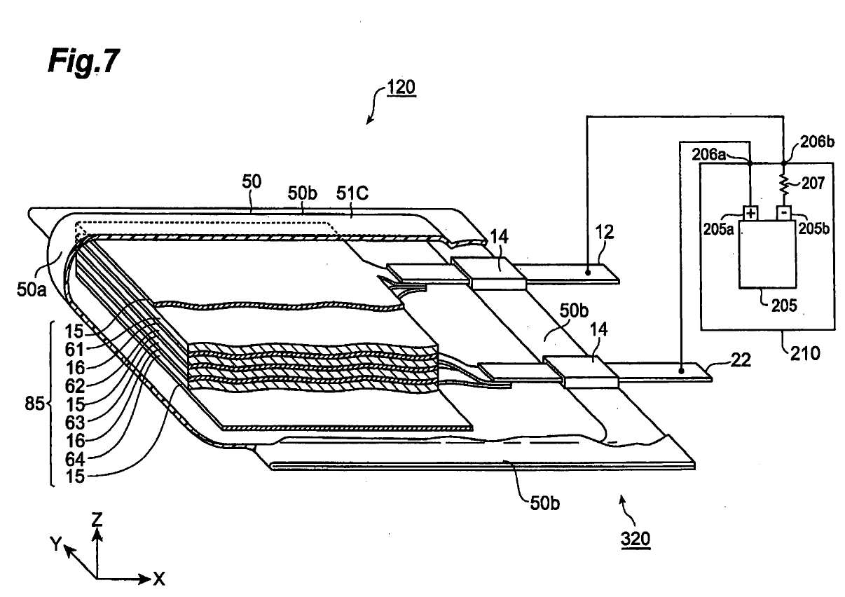

The power supply charging apparatus and system in accordance with a third embodiment will now be explained with reference to FIG. 7. The power supply 120 in accordance with this embodiment differs from that of the first embodiment in that the resistor 13 is not connected to the middle of the lead 12. The charging apparatus 210 of the third embodiment differs from the charging apparatus of the first embodiment in that a resistor 207 is connected between the output terminal 205b and the terminal 206b. The ohmic value, specific resistance, and the like of the resistor 207 are the same as those of the resistor 13 in the first embodiment. Here, the power supply 120 and the charging apparatus 210 constitute a charging system 320.

The resistor 207 suppresses the charging current at the initial stage of charging in the charging apparatus and system in accordance with this embodiment as in the first embodiment also when the power supply 120 including a conventional lithium-ion secondary battery without the resistor 13 is subjected to constant voltage charging.

Without being restricted to the above-mentioned embodiments, the present invention can be modified in various manners.

For example, though the resistor 13 is disposed in the middle of the lead 12 in the first and second embodiments, the resistor 13 may be disposed in the middle of the lead 22 or divided so as to be positioned in the middle of the lead 12 and in the middle of the lead 22.

Though the resistor 207 is connected between the output terminal 205b and terminal 206b of the negative electrode in the charging apparatus 210 in the third embodiment, it may be disposed between the output terminal 205a and terminal 206a of the positive electrode as well. The resistor 207 may also be connected between the output terminal 205b and terminal 206b of the negative electrode and between the output terminal 205a and terminal 206a of the positive electrode at the same time.

Though lithium-ion secondary battery elements are employed as secondary battery elements in the above-mentioned embodiments, the present invention is also applicable to other items, e.g., nickel-hydride batteries.

### EXAMPLES

The present invention will now be explained in further detail with reference to Example and Comparative Example, which do not restrict the present invention at all.

In the following procedure, a power supply including a lithium-ion secondary battery was made. Here, a lithium-ion secondary battery including 12 layers of lithium-ion secondary battery elements was used.

### Example 1

First, cathode laminates were made in the following procedure. Initially, LiMn_{0.33}Ni_{0.33}CO_{0.34}O₂ (where the subscripts indicate atomic ratios) as a cathode active material, acetylene black as a conductive auxiliary agent, and polyvinylidene fluoride (PVdF) as a binder were prepared. They were mixed and dispersed by a planetary mixer such that the weight ratio of cathode active material/conductive auxiliary agent/binder=90:6:4. Then, the viscosity of the resulting product was adjusted with an appropriate amount of NMP as a solvent mixed therein, whereby a slurry-like cathode coating liquid (slurry) was prepared.

Subsequently, an aluminum foil (having a thickness of 20 μm) was prepared, and the cathode coating liquid was applied thereto by doctor blading such as to yield an active material support amount of 5.5 mg/cm² and then was dried. Thus obtained product was pressed with calender rolls such that the applied cathode layer attained a porosity of 28%. The pressed product -was cut out into a form having a cathode surface with a size of 17×32 mm and a predetermined tongue terminal, whereby a cathode laminate was obtained. Here, cathode laminates each having a cathode formed on only one side, and cathode laminates each having both sides formed with cathodes were made.

Next, anode laminates were made in the following manner. First, natural graphite (MSG manufactured by BTR) as an anode active material, and PVdF as a binder were prepared. They were compounded such that the weight ratio of anode active material/binder=95:5, and were mixed and dispersed by a planetary mixer. Then, the viscosity of the resulting product was adjusted with an appropriate amount of NMP as a solvent fed therein, whereby a slurry-like anode coating liquid (slurry) was prepared.

Next, a copper foil (having a thickness of 15 μm) as a collector was prepared, and the anode coating liquid was applied to both sides of the copper foil by doctor blading such as to yield an anode active material support amount of 3.0 mg/cm² and then was dried, whereby an anode laminate was obtained. Thus obtained product was pressed with calender rolls such that the anode layer attained a porosity of 30%. The pressed product was cut out into a form having an anode surface with a size of 17×32 mm and a predetermined tongue terminal, whereby an anode laminate was obtained.

Next, a porous film made of polyolefin (with a thickness of 25 μm yielding a Gurley permeation time of 100 s) was cut out into a size of 18 mm×33 mm, so as to become a separator.

Subsequently, the anode and cathode laminates were successively laminated so as to alternate with separators, whereby a laminate structure including 12 layers of lithium-ion secondary battery elements were obtained. The laminate structure was pressed under heat from both end faces, so as to be fixed. They were laminated such that the cathode laminates each having one side formed with a cathode were arranged as the outermost layers of the laminate structure.

Next, a nonaqueous electrolytic solution was prepared as follows. Propylene carbonate (PC), ethylene carbonate (EC), and diethyl carbonate (DEC) were mixed so as to yield a volume ratio of 2:1:7 in this order, whereby a solvent was obtained. Subsequently, LiPF₆ was dissolved in the solvent such as to yield a concentration of 1.5 mol/dm³. Further, 3 parts by weight of 1,3-propane sultone were added to 100 parts by weight of the solution, whereby a nonaqueous electrolytic solution was obtained.

Then, a case formed by a bag-shaped aluminum laminate film was prepared, and the nonaqueous electrolytic solution was injected therein in a vacuum chamber, so that the laminate structure was dipped in the nonaqueous electrolytic solution. Thereafter, still at a reduced pressure, the entrance part of the package was sealed such that each tongue terminal partly projected out of the package, and initial charging/discharging was performed, whereby a power supply including a laminated lithium-ion secondary battery having a capacity of 50 mAh was obtained.

Next, with a resistor of 0.8 Ω connected between the terminal on the anode side of the lithium-ion secondary battery in thus obtained power supply and the negative electrode terminal of the constant voltage charging apparatus, charging was performed at a constant voltage of 4.2 V at room temperature, whereby a cycle test was carried out. The charging was terminated when the current value was lowered to 0.05 C, whereas discharging was performed at 10 C (500 mA) and was terminated when the terminal voltage became 2.5 V. The DC internal resistance value of this lithium-ion secondary battery was 0.170 Ω.

As a result, the maximum current at the time of charging was 1.2 A, whereas the capacity keeping ratio after 100 cycles was 92.1%.

### Comparative Example 1

The lithium-ion secondary battery was charged as in Example 1 except that no resistor was connected between the lithium-ion secondary battery and constant voltage charging apparatus.

As a result, the maximum current at the time of charging was 6 A, whereas the capacity keeping ratio after 100 cycles was 57.7%.

1. A power supply comprising:
a secondary battery including a pair of electrodes; and
a resistor electrically connected to at least one polarity side of the pair of electrodes.

2. A power supply according to claim 1, wherein the secondary battery comprises a plurality of secondary battery elements connected in parallel.

3. A power supply according to claim 1, wherein an ohmic value of the resistor is 1.5 to 25 times a DC internal resistance value of the secondary battery.

4. A power supply according to claim 1, further comprising:
a package for accommodating the secondary battery;
a first lead having one end disposed within the package and electrically connected to the electrode on the one polarity side of the secondary battery, and the other end projecting out of the package; and
a second lead having one end disposed within the package and electrically connected to the electrode on the other polarity side of the secondary battery, and the other end projecting out of the package;
wherein the resistor is connected to a middle part of at least one of the first and second leads.

5. A power supply according to claim 4, wherein the resistor is connected to a middle part of a portion accommodated within the package in at least one of the first and second leads.

6. A power supply according to claim 4, wherein the resistor is connected to a middle part of a portion exposed to the outside of the package in at least one of the first and second leads.

7. A power supply according to claim 1, wherein the secondary battery is a lithium-ion secondary battery.

8. A charging apparatus comprising:
a first terminal to be electrically connected to an electrode on one polarity side of a secondary battery;
a second terminal to be electrically connected to an electrode on the other polarity side of the secondary battery;
constant voltage generating means for generating a constant voltage between a pair of output terminals; and
a resistor;
wherein one of the output terminals of the constant voltage generating means is electrically connected to the first terminal; and
wherein the other terminal of the constant voltage generating means is electrically connected to the second terminal by way of the resistor.

9. A charging system comprising:
a secondary battery including a pair of electrodes;
a first terminal electrically connected to an electrode on one polarity side of the secondary battery;
a second terminal electrically connected to an electrode on the other polarity side of the secondary battery;
constant voltage generating means for generating a constant voltage between a pair of output terminals; and
a resistor;
wherein one of the output terminals of the constant voltage generating means is electrically connected to the first terminal; and
wherein the other terminal of the constant voltage generating means is electrically connected to the second terminal by way of the resistor.
